(19) United States
(12) Patent Application Publication
(10) Pub. No.: US 2016/0099676 A1
(43) Pub. Date: Apr. 7, 2016

(54) METHOD AND APPARATUS FOR AN INTEGRATED PV CURVE TRACER

(71) Applicant: Enphase Energy, Inc., Petaluma, CA (US)

(72) Inventor: Martin Fornage, Petaluma, CA (US)

(21) Appl. No.: 14/869,202

(22) Filed: Sep. 29, 2015

Related U.S. Application Data
(60) Provisional application No. 62/058,248, filed on Oct. 1, 2014.

(51) Int. Cl. G01R 31/40; H02S 40/34

(52) U.S. Cl. CPC H02S 50/00; H02S 40/34

(57) ABSTRACT

Method and apparatus for obtaining photovoltaic (PV) module I-V curve data. In one embodiment, the method comprises reducing an operating voltage of a PV module coupled to a power conditioner to a minimum operating value; once the operating voltage has stabilized at the minimum operating value, stopping power production in the power conditioner; and determining, by the power conditioner, a plurality of sets of I-V curve data from PV module, wherein each set of I-V curve data in the plurality of sets comprises a voltage value indicating output voltage from the PV module and a current value indicating output current from the PV module.

### CROSS-REFERENCE TO RELATED APPLICATION

This application claims priority to U.S. Provisional Patent Application No. 62/058,248, entitled “Integrated PV Curve Tracer” and filed on Oct. 1, 2014, which is herein incorporated in its entirety by reference.

### BACKGROUND OF THE INVENTION

1. Field of the Invention

Embodiments of the present disclosure generally relate to power conversion and, more particularly, to a method and apparatus for tracing an I-V curve of a photovoltaic module coupled to a power converter.

2. Description of the Related Art

Photovoltaic (PV) modules convert energy from sunlight received into direct current (DC). The PV modules cannot store the electrical energy they produce, so the energy must either be dispersed to an energy storage system, such as a battery or pumped hydroelectricity storage, or dispersed by a load. One option to use the energy produced is to employ one or more inverters to convert the DC current into an alternating current (AC) and couple the AC current to the commercial power grid. The power produced by such a distributed generation (DG) system can then be sold to the commercial power company.

The current and voltage generated by a PV module can be expressed in the form of an I-V curve which depicts the current (I) generated by the PV module as a function of its voltage (V). For PV modules deployed outdoors, the I-V curve can be useful to diagnose the health of a PV module as well as to determine if the PV module is operating at its rated behavior.

Therefore, there is a need in the art for a method and apparatus for tracing the I-V curve of a deployed PV module.

### SUMMARY OF THE INVENTION

Embodiments of the present invention generally relate to a method and apparatus for obtaining photovoltaic (PV) module I-V curve data substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a system for distributed generation (DG) in accordance with one or more embodiments of the present invention;

FIG. 2 is a block diagram of a power conditioner in accordance with one or more embodiments of the present invention;

FIG. 3 is a block diagram of a system control module in accordance with one or more embodiments of the present invention;

FIG. 4 is a flow diagram of a method for obtaining PV module current and voltage data to trace an I-V curve in accordance with one or more embodiments of the present invention; and

FIG. 5 is a flow diagram of a method for obtaining PV module current and voltage data to trace an I-V curve in accordance with one or more alternative embodiments of the present invention.

### DETAILED DESCRIPTION

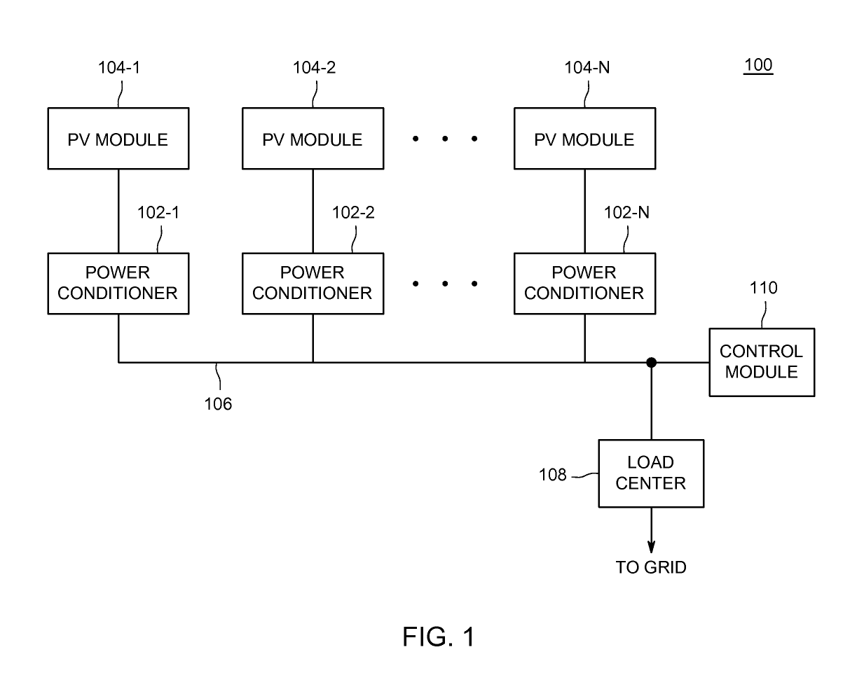

FIG. 1 is a block diagram of a system 100 for distributed generation (DG) in accordance with one or more embodiments of the present invention. This diagram only portrays one variation of the myriad of possible system configurations. The present invention can function in a variety of distributed power generation environments and systems.

The system 100 comprises a plurality of power conditioners 102₁, 102₂ . . . 102ₙ, collectively referred to as power conditioners 102, a plurality of PV modules 104₁, 104₂ . . . 104ₙ, collectively referred to as PV modules 104, a power bus 106, a load center 108, and a system control module 110.

Each power conditioner 102₁, 102₂ . . . 102ₙ is coupled to a PV module 104₁, 104₂ . . . 104ₙ, respectively, in a one-to-one correspondence and converts DC power from the corresponding PV module 104 to an output power. In some embodiments, such as the embodiment described below, the power conditioners 102 are DC-AC inverters that convert DC power from the PV modules 104 to AC power.

The power conditioners 102 are coupled to the power bus 106 (i.e., an AC bus in the embodiment described here), which in turn is coupled to the system control module 110 and the load center 108. The system control module 110 (e.g., a gateway) is capable of communicating with the power conditioners 102, for example for issuing command and control signals to the power conditioners 102 and/or for receiving information from the power conditioners 102.

The load center 108 houses connections between incoming power lines from a power grid distribution system and the power bus 106. The power conditioners 102 convert DC power from the PV modules 104 into AC power and generally meter out AC current that is in-phase with the AC power grid voltage, although the power conditioners 102 may additionally or alternatively generate reactive power (Volt-Ampere reactive, or VAr). The system 100 couples the generated AC power to the power grid via the load center 108. Additionally or alternatively, the generated power may be distributed for use via the load center to one or more appliances, and/or the generated energy may be stored for later use, for example using batteries, heated water, hydro pumping, H₂O-to-hydrogen conversion, or the like. In some alternative embodiments, the power conditioners 102 may be other types of power converters, such as DC-DC converters; for example, the power conditioners may be DC-DC converters that are followed by a DC-AC converter or by a DC power network.

In accordance with one or more embodiments of the present invention, each of the power conditioners 102 comprises an integrated I-V curve tracer for obtaining the I-V data of the corresponding PV module 104 as described in detail below. The I-V data may then be communicated to the system control module 110, e.g., via power line communications (PLC) and/or other types of wired or wireless techniques. The system control module 110 may further communicate the I-V data via wireless and/or wired communication techniques to another device (not shown), such as a master controller, for analysis and/or display. For example, the system control module 110 may wirelessly communicate the I-V data to a master controller via the Internet. The master controller may then store the I-V data, generate one or more I-V curves using the I-V data, compare one or more of the I-V curves to theoretical or vendor-provided I-V curves, or perform other functions for determining the health of one or more PV modules 104 using its corresponding I-V curve.

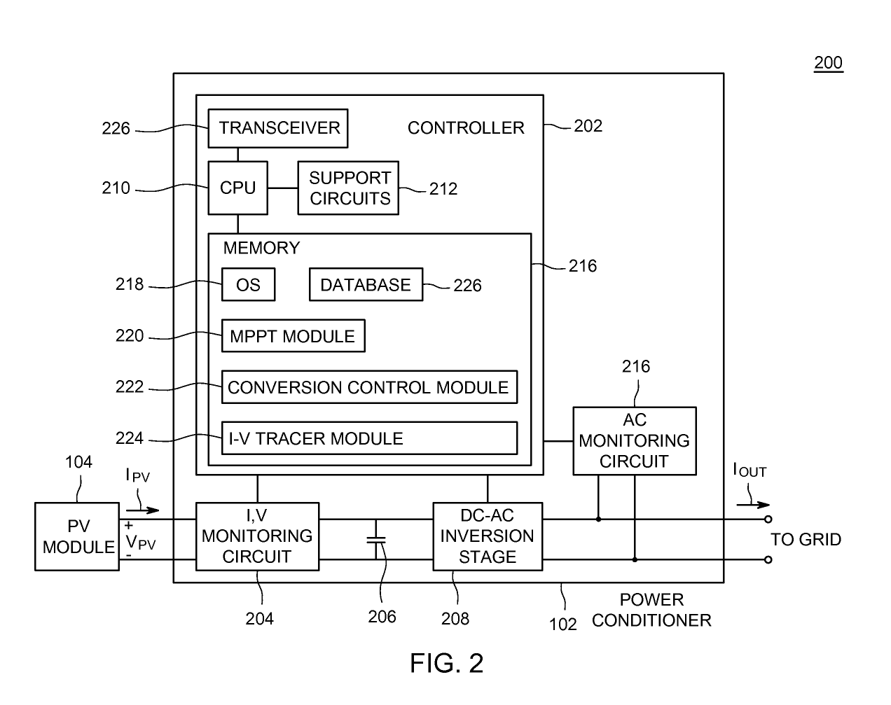

FIG. 2 is a block diagram of a power conditioner 102 in accordance with one or more embodiments of the present invention. The power conditioner 102 comprises an I-V monitoring circuit 204, an input capacitor 206 (i.e., an energy storage device), a DC-AC inversion stage 208, an AC monitoring circuit 216, and a controller 202.

The I-V monitoring circuit 204 is coupled between the PV module 104 and the input capacitor 206. The DC-AC inversion stage 208 is coupled between the input capacitor 206 and the output terminals of the power conditioner 102, and the AC monitoring circuit 216 is coupled across the output from the DC-AC inversion stage 208. The controller 202 is coupled to each of the I-V monitoring circuit 204, the DC-AC inversion stage 208, and the AC monitoring circuit 216.

The I-V monitoring circuit 204 provides a means for sampling the DC current and voltage at the input of the power conditioner 102 (i.e., the PV module DC current I_{PV} and DC voltage V_{PV}), and the AC monitoring circuit 216 provides a means for sampling the AC current and voltage at the output of the power conditioner 102. The I-V monitoring circuit 204 and the AC monitoring circuit 216 provide such samples (i.e., signals indicative of the sampled currents and voltages) to the controller 202 for use in operatively controlling the DC-AC inversion stage 208.

The controller 202 comprises at least one central processing unit (CPU) 210 coupled to each of a transceiver 226, support circuits 212 and to a memory 216. The CPU 210 may comprise one or more processors, microprocessors, microcontrollers and combinations thereof configured to execute non-transient software instructions to perform various tasks in accordance with the present invention. In some embodiments, the CPU 210 may be a microcontroller comprising internal memory for storing controller firmware that, when executed, provides the controller functionality described herein. The CPU 210 may additionally or alternatively include one or more application specific integrated circuits (ASICs).

The transceiver 226 may, in some embodiments, be coupled to the AC output lines from the power conditioner 102 for communicating with the system control module 110 using PLC. Additionally or alternatively, the transceiver 226 may utilize wireless (e.g., based on standards such as IEEE 802.11, Zigbee, Z-wave, or the like) and/or other types of wired communication techniques for communicating with the system control module 110 and/or a master controller, for example a WI-FI or WI-MAX modem, 3G modem, cable modem, Digital Subscriber Line (DSL), fiber optic, or similar type of technology.

The support circuits 212 are well known circuits used to promote functionality of the CPU 210. Such circuits include, but are not limited to, a cache, power supplies, clock circuits, buses, network cards, input/output (I/O) circuits, and the like. The controller 202 may be implemented using a general purpose computer that, when executing particular software, becomes a specific purpose computer for performing various embodiments of the present invention.

The memory 216 may comprise random access memory, read only memory, removable disk memory, flash memory, and various combinations of these types of memory. The memory 216 is sometimes referred to as main memory and may, in part, be used as cache memory or buffer memory. The memory 216 generally stores the operating system (OS) 218 of the controller 202. The operating system 218 may be one of a number of commercially available operating systems such as, but not limited to, Linux, Real-Time Operating System (RTOS), and the like.

The memory 216 stores non-transient processor-executable instructions and/or data that may be executed by and/or used by the CPU 210. These processor-executable instructions may comprise firmware, software, and the like, or some combination thereof.

The memory 216 may store various forms of application software, such as a maximum power point tracking (MPPT) module 220, a conversion control module 222, and an I-V tracer module 224. The memory 216 may additionally comprise a database 226 for storing data related to the operation of the power conditioner 102 and/or the present invention. In some embodiments, one or more of the MPPT module 220, the conversion control module 222, the I-V tracer module 224, or the database 226, or portions thereof, may be implemented in software, firmware, hardware, or a combination thereof.

During operation of the power conditioner 102, the MPPT module 220 provides maximum power point tracking for operating the corresponding PV module 104 at its maximum power point (MPP) and generates a DC voltage setpoint for biasing the PV module 104 at the desired MPP. The conversion control module 222 drives the DC-AC inversion stage 208 to generate a required current I_{req} such that the PV module 104 is biased at the desired DC voltage setpoint.

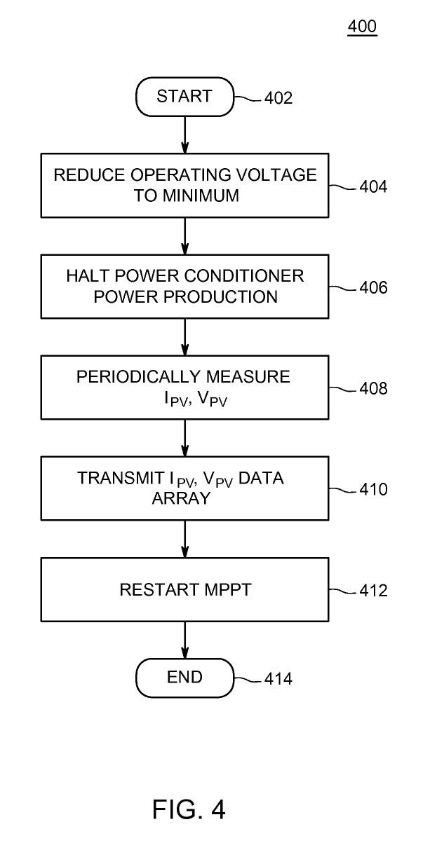

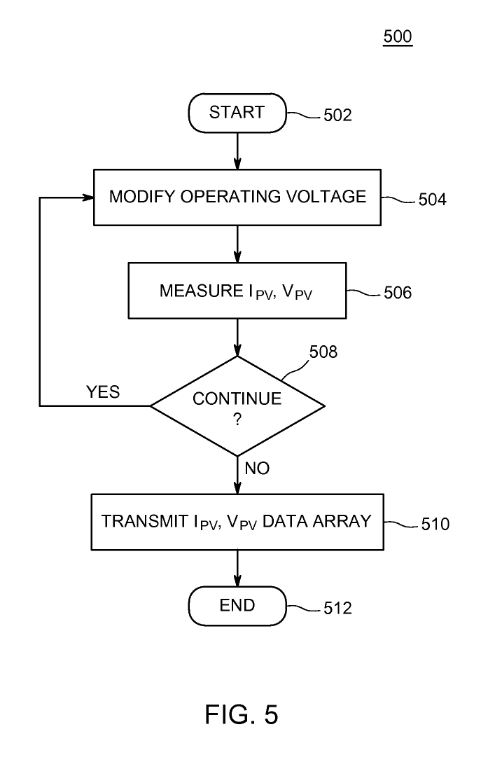

In accordance with one or more embodiments of the present invention, the I-V tracer module 224 is executed for obtaining a plurality of corresponding PV module current and voltage data points (i.e., an array of I_{PV}, V_{PV} data points) as described below with respect to FIGS. 4 and 5. In some embodiments, the I-V tracer module 224 employs the MPPT module 220 to characterize the curve without the need to disconnect either the DC or the AC side of the power conditioner 102. The I_{PV}, V_{PV} data array may then be communicated to the system control module 110 for determining the PV module I-V curve, although in certain embodiments the power conditioner 102 may additionally determine the PV module I-V curve.

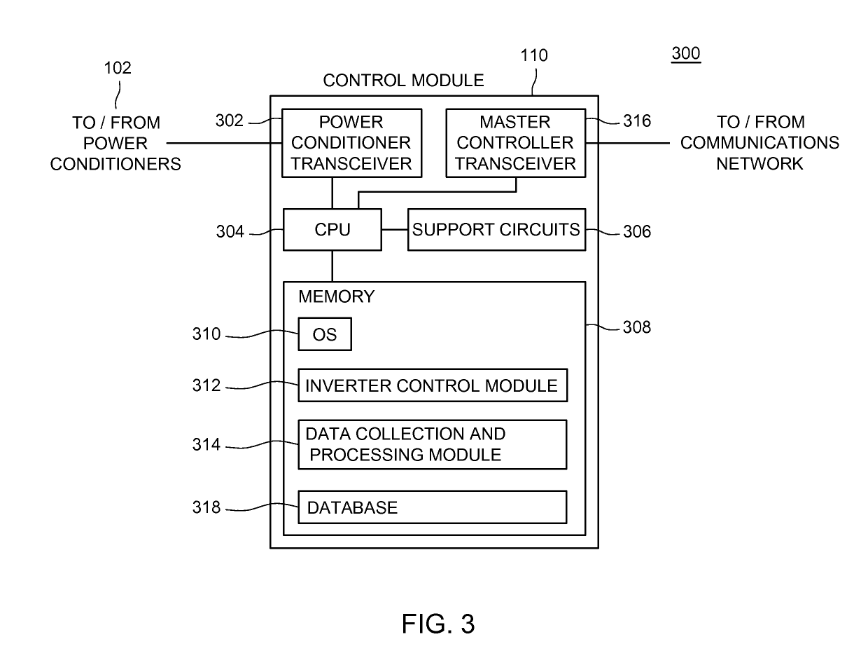

FIG. 3 is a block diagram of a system control module 110 in accordance with one or more embodiments of the present invention. The system control module 110 comprises a master controller transceiver 316 communicatively coupled to a communications network (not shown), and a power conditioner transceiver 302 communicatively coupled to the power conditioners 102. The transceivers 302 and 316 may utilize wireless (e.g., based on standards such as IEEE 802.11, Zigbee, Z-wave, or the like) and/or wired (e.g., PLC) communication techniques for such communication, for example a WI-Fl or WI-MAX modem, 3G modem, cable modem, Digital Subscriber Line (DSL), fiber optic, or similar type of technology.

The system control module 110 further comprises at least one central processing unit (CPU) 304 coupled to each of the inverter transceiver 302 and the master controller transceiver 316, support circuits 306, and a memory 308. The CPU 304 may comprise one or more conventionally available microprocessors; alternatively, the CPU 204 may include one or more application specific integrated circuits (ASIC). In some embodiments, the CPU 304 may be a microcontroller comprising internal memory for storing controller firmware that, when executed, provides the control module functionality described herein. The system control module 110 may be implemented using a general purpose computer that, when executing particular software, becomes a specific purpose computer for performing various embodiments of the present invention.

The support circuits 306 are well known circuits used to promote functionality of the CPU 304. Such circuits include, but are not limited to, a cache, power supplies, clock circuits, buses, network cards, input/output (I/O) circuits, and the like.

The memory 308 may comprise random access memory, read only memory, removable disk memory, flash memory, and various combinations of these types of memory. The memory 308 is sometimes referred to as main memory and may, in part, be used as cache memory or buffer memory. The memory 308 generally stores an operating system (OS) 310 of the system control module 110. The OS 310 may be one of a number of available operating systems for microcontrollers and/or microprocessors.

The memory 308 may store various forms of application software, such as a power conditioner control module 312 for providing operative control of the power conditioners 102 (e.g., providing command instructions to the power conditioners 102 for controlling power generation, obtaining I_{PV}, V_{PV} data array for the corresponding PV modules 104, and the like). The memory 308 further comprises a data collection/processing module 314 for collecting and processing the I_{PV}, V_{PV} data. For example, in some embodiments the system control module 110 may generate one or more I-V curves based on the I_{PV}, V_{PV} data as well as analyze the generated I-V curves for determining the health of the PV modules 104. Additionally or alternatively, the system control module 110 may communicate the collected I_{PV}, V_{PV} data to a master controller (not shown) for generating the I-V curves and/or analyzing the health of the PV modules 104. The memory 308 may also store a database 318 for storing data related to the operation of the power conditioners 102 and/or the present invention (e.g., collected I_{PV}, V_{PV} data).

FIG. 4 is a flow diagram of a method 400 for obtaining PV module current and voltage data to trace an I-V curve in accordance with one or more embodiments of the present invention. In some embodiments, such as the embodiment described below, a power conditioner is coupled to a PV module (e.g., the power conditioner 102 coupled to the PV module 104) and the power conditioner is coupled to both a system control module that may perform gateway functions (e.g., the system control module 110) and a power grid via a power bus (e.g., an AC power grid via an AC bus). In one embodiment, the method 400 is an implementation of the I-V tracer module 224. The method 400 may be initiated periodically (e.g., automatically at pre-determined intervals) or on-demand (e.g., by a command received, for example, via the system control module or directly from a source via, for example, the AC power lines).

The method 400 starts at step 402 and proceeds to step 404. At step 404, the PV module operating voltage is reduced to a minimum that will allow the power conditioner to remain operational. In some embodiments, a maximum power point tracker (e.g., MPPT module 220) may be employed to set the PV module DC set point at a pre-determined minimum voltage, for example 12 volts. The minimum operating voltage may be stored in a power conditioner database (e.g., the database 226) or alternatively communicated to the power conditioner (e.g., via the AC power lines).

The method 400 proceeds to step 406. Once the operating voltage has stabilized at the minimum point, the power production by the power conditioner is stopped (i.e., current output from the power conditioner is stopped). As a result, the voltage across the PV module rises while the current from the PV module falls as energy from the PV module is stored in the power conditioner's input capacitor. The method 400 proceeds to step 408 where I_{PV} and V_{PV} are simultaneously measured at periodic intervals, for example every 30 microseconds, to obtain a plurality of sets of I-V curve data (i.e., the data array) where each set of I-V curve data comprises an I_{PV} value (i.e., a current value indicating the output current from the PV module) and a corresponding V_{PV} value (i.e., a voltage value indicating the output voltage from the PV module). In some alternative embodiments, rather than being measured I_{PV} may be inferred by I_{PV}=I_{PC}=C×(dV_{PV}/dt) where the coefficient C is known or an approximation of C is known and dV_{PV}/dt is the change in PV module output voltage over time. The obtained I_{PV}, V_{PV} data points may then be stored, for example in a table within a power conditioner database, although in some embodiments the obtained I_{PV}, V_{PV} data points may be communicated to a system control module as they are obtained by the power conditioner. The I_{PV}, V_{PV} data points may continue to be measured until one or both of I_{PV} and V_{PV} are at a minimum (for example, over a time period on the order or tens of milliseconds).

The method 400 proceeds to step 410. At step 410, the array of I_{PV}, V_{PV} data points is communicated from the power conditioner to the system controller. The array may be communicated once all of the data has been obtained or, alternatively, at a pre-set time. The system controller may store the received data, provide a visual display of the data as an I-V curve, analyze the data to determine the health of the PV module (e.g., via curve-fitting, by comparing the I-V curve to theoretical I-V curves or vendor-provided I-V curves, or the like), or perform other similar functions. Additionally or alternatively, the system controller may communicate the data to a master controller for performing one or more of such functions, or communicate the data to a customer. The method 400 then proceeds to step 412 where MPPT is resumed for operating at a maximum power point. The method 400 then proceeds to step 414 it ends.

FIG. 5 is a flow diagram of a method 500 for obtaining PV module current and voltage data to trace an I-V curve in accordance with one or more alternative embodiments of the present invention. In some embodiments, such as the embodiment described below, a power conditioner is coupled to a PV module as depicted in FIG. 1, although the power conditioner either does not have an input capacitor such as the input capacitor 206, or the power conditioner does have an input capacitor such as the input capacitor 206 but its capacitance is too low to implement the method 400. The power conditioner is coupled to both a system control module that may perform gateway functions (e.g., the system control module 110) and a power grid via a power bus (e.g., an AC power grid via an AC power bus). In one embodiment, the method 500 is an implementation of the I-V tracer module 224. The method 500 may be initiated periodically (e.g., automatically at pre-determined intervals) or on-demand (e.g., by a command received, for example, via the system control module or directly from a source via, for example, the AC power lines).

The method 500 starts at step 502 and proceeds to step 504. At step 504, the operating voltage is reduced by an incremental amount, such as 1 volt. Once operation has stabilized at the modified operating voltage, the method 500 proceeds to step 506 where I_{PV} and V_{PV} are simultaneously measured. The obtained I_{PV}, V_{PV} data points may then be stored, for example in a table within a power conditioner database, although in some embodiments the obtained I_{PV}, V_{PV} data points may be communicated to the system control module as they are obtained by the power conditioner. The method 500 proceeds to step 508, where a determination is made whether to continue based on whether the voltage has stabilized to the open circuit voltage Voc. If the result of the determination is to continue, i.e., the voltage has not yet stabilized to Voc, the method 500 returns to step 504 to further incrementally reduce the operating voltage and obtain an additional I_{PV}, V_{PV} data measurement. In some other embodiments, rather than incrementally reducing the operating voltage and measuring the resulting PV module current and voltage, the operating voltage may be reduced to some minimum level and then incrementally increased to measure the PV module current and voltage.

If the result of the determination at step 508 is to not continue, i.e., the voltage has stabilized to Voc, the method 500 proceeds to step 510. At step 510, the array of I_{PV}, V_{PV} data points is communicated from the power conditioner to the system controller. The array may be communicated once all of the data has been obtained or, alternatively, at a pre-set time. The system controller may store the received data, provide a visual display of the data as an I-V curve, analyze the data to determine the health of the PV module (e.g., via curve-fitting, by comparing the I-V curve to theoretical I-V curves or vendor-provided I-V curves, or the like), or perform other similar functions. Additionally or alternatively, the system controller may communicate the data to a master controller for performing one or more of such functions, or communicate the data to a customer. The method 500 then proceeds to step 512 where it ends.

In some embodiments, the method 400 or the method 500 may be implemented by only a single power conditioner at a time. In other embodiments, the method 400 or the method 500 may be implemented at the same time by a plurality of the inverters 102; although such operation may result in a drop of power production by the system 100 depending on how many power conditioners 102 are performing the I-V tracing, having PV module I-V data obtained at the same time for a plurality of PV modules may assist in analyzing the health of the PV modules. Additionally, the wiring resistance can be determined if the I-V tracing is implemented at the same time for all of the power conditioners 102. For example, if power export is halted for one or two grid cycles to perform the I-V tracing, the AC voltage on each unit can be measured at the same time and compared to the corresponding AC voltage during power production; such information can be used along with data for the total amount of current through the system during power production to determine the resistance (i.e., the AC impedance of the AC wiring, or the DC resistance of the DC wiring in case of a DC distribution system).

The foregoing description of embodiments of the invention comprises a number of elements, devices, circuits and/or assemblies that perform various functions as described. These elements, devices, circuits, and/or assemblies are exemplary implementations of means for performing their respectively described functions.

While the foregoing is directed to embodiments of the present invention, other and further embodiments of the invention may be devised without departing from the basic scope thereof, and the scope thereof is determined by the claims that follow.

1. A method for obtaining photovoltaic (PV) module I-V curve data, comprising:
reducing an operating voltage of a PV module coupled to a power conditioner to a minimum operating value;
once the operating voltage has stabilized at the minimum operating value, stopping power production in the power conditioner, wherein after stopping the power production, energy from the PV module is stored in a storage device of the power conditioner; and
determining, by the power conditioner, a plurality of sets of I-V curve data from PV module, wherein each set of I-V curve data in the plurality of sets comprises a voltage value indicating output voltage from the PV module and a current value indicating output current from the PV module.

2. The method of claim 1, wherein reducing the operating voltage is done by setting a DC set point for the PV module to a minimum voltage.

3. The method of claim 1, wherein determining the plurality of sets of I-V curve data comprises, for each set of I-V curve data in the plurality of sets, simultaneously measuring the output voltage and the output current to obtain the voltage value and the current value, respectively.

4. The method of claim 1, wherein determining the plurality of sets of I-V curve data comprises, for each set of I-V curve data in the plurality of sets, (i) measuring the output voltage to obtain the voltage value and (ii) computing the current value based on the measured output voltage.

5. The method of claim 4, wherein the current value is equal to C×(dV_{PV}/dt), wherein is a coefficient and dV_{PV}/dt is a change PV module output voltage over time.

6. The method of claim 1, wherein the power conditioner is a DC-AC inverter, and wherein the plurality of sets of I-V curve data is determined while the DC-AC inverter remains coupled to the PV module and to an AC line.

7. An apparatus for obtaining photovoltaic (PV) module I-V curve data, comprising:
a power conditioner, coupled to a PV module, for (a) reducing an operating voltage of the PV module to a minimum operating value; (b) once the operating voltage has stabilized at the minimum operating value, stopping power production wherein after stopping the power production, energy from the PV module is stored in a storage device of the power conditioner; and (c) determining a plurality of sets of I-V curve data from PV module, wherein each set of I-V curve data in the plurality of sets comprises a voltage value indicating output voltage from the PV module and a current value indicating output current from the PV module.

8. The apparatus of claim 7, wherein reducing the operating voltage is done by setting a DC set point for the PV module to a minimum voltage.

9. The apparatus of claim 7, wherein determining the plurality of sets of I-V curve data comprises, for each set of I-V curve data in the plurality of sets, simultaneously measuring the output voltage and the output current to obtain the voltage value and the current value, respectively.

10. The apparatus of claim 7, wherein determining the plurality of sets of I-V curve data comprises, for each set of I-V curve data in the plurality of sets, (i) measuring the output voltage to obtain the voltage value and (ii) computing the current value based on the measured output voltage.

11. The apparatus of claim 10, wherein the current value is equal to C×(dV_{PV}/dt), wherein is a coefficient and dV_{PV}/dt is a change PV module output voltage over time.

12. The apparatus of claim 7, wherein the power conditioner is a DC-AC inverter, and wherein the plurality of sets of I-V curve data is determined while the DC-AC inverter remains coupled to the PV module and to an AC line.

13. A system for obtaining photovoltaic (PV) module I-V curve data, comprising:
a PV module; and
a power conditioner, coupled to a PV module, for (a) reducing an operating voltage of the PV module to a minimum operating value; (b) once the operating voltage has stabilized at the minimum operating value, stopping power production wherein after stopping the power production, energy from the PV module is stored in a storage device of the power conditioner; and (c) determining a plurality of sets of I-V curve data from PV module, wherein each set of I-V curve data in the plurality of sets comprises a voltage value indicating output voltage from the PV module and a current value indicating output current from the PV module.

14. The system of claim 13, wherein reducing the operating voltage is done by setting a DC set point for the PV module to a minimum voltage.

15. The system of claim 13, wherein determining the plurality of sets of I-V curve data comprises, for each set of I-V curve data in the plurality of sets, simultaneously measuring the output voltage and the output current to obtain the voltage value and the current value, respectively.

16. The system of claim 13, wherein determining the plurality of sets of I-V curve data comprises, for each set of I-V curve data in the plurality of sets, (i) measuring the output voltage to obtain the voltage value and (ii) computing the current value based on the measured output voltage.

17. The system of claim 16, wherein the current value is equal to C×(dV_{PV}/dt), wherein is a coefficient and dV_{PV}/dt is a change PV module output voltage over time.

18. The system of claim 13, wherein the power conditioner is a DC-AC inverter, and wherein the plurality of sets of I-V curve data is determined while the DC-AC inverter remains coupled to the PV module and to an AC line.

19. The system of claim 18, further comprising a system control module coupled to the DC-AC inverter via the AC line, wherein the DC-AC inverter communicates the plurality of sets of I-V curve data to the system control module via the AC line.

20. The system of claim 19, wherein the system control module analyzes the plurality of sets of I-V curve data to determine the health of the PV module.
